(19) United States
(12) Patent Application Publication
(10) Pub. No.: US 2024/0267159 A1
(43) Pub. Date: Aug. 8, 2024

(54) MANAGING MAC PDU TRANSMISSIONS

(71) Applicant: Lenovo (Singapore) Pte. Ltd., New Tech Park (SG)

(72) Inventors: Joachim Löhr, Wiesbaden (DE); Alexander Golitschek Edler von Elbwart, Darmstadt (DE)

(21) Appl. No.: 18/566,470

(22) PCT Filed: Jun. 1, 2022
(86) PCT No.: PCT/IB22/55098

§ 371 Date: Dec. 1, 2023

Related U.S. Application Data
(60) Provisional application No. 63/195,548, filed on Jun. 1, 2021.

(51) Int. Cl. H04L 1/1822; H04L 1/1867

(52) U.S. Cl. CPC H04L 1/1822; H04L 1/1874; H04L 1/1887; H04L 1/189; H04L 1/1896

(57) ABSTRACT

Apparatuses, methods, and systems are disclosed for managing MAC PDU transmissions. An apparatus (300) includes a processor (305) that generates an empty MAC PDU according to an UL CG, the empty MAC PDU free of any MAC SDUs. The apparatus (300) includes a transceiver (325) that instructs the physical layer to transmit, to a network, the empty MAC PDU on a HARQ process associated with the UL CG. The processor (305) prevents autonomous retransmission of the empty MAC PDU to the network.

### CROSS-REFERENCE TO RELATED APPLICATION

This application claims priority to U.S. Provisional Patent Application No. 63/195,548 entitled “UCI-ONLY MAC PDU TRANSMISSIONS” and filed on Jun. 1, 2021, for Joachim Löhr, et al., which is incorporated herein by reference.

### FIELD

The subject matter disclosed herein relates generally to wireless communications and more particularly relates to managing medium access control (“MAC”) protocol data unit (“PDU”) transmissions.

### BACKGROUND

In Third Generation Partnership Project (“3GPP”) new radio (“NR”), the process by which a user equipment (“UE”) creates a MAC PDU for transmission on the uplink using the allocated radio resources is standardized. This ensures that the UE satisfies the quality of service (“QoS”) of each configured radio bearer in a way that is optimal and consistent between different UE implementations. Based on the uplink transmission resource grant message signaled on the physical downlink control channel (“PDCCH”), e.g., via downlink control information (“DCI”), the UE decides on the amount of data for each logical channel to be included in the new MAC PDU, and, if necessary, also allocates space for a MAC Control Element (“CE”). The logical channel prioritization procedure (“LCP”) is applied when a new transmission is performed.

### BRIEF SUMMARY

Disclosed are solutions for managing MAC PDU transmissions. The solutions may be implemented by apparatus, systems, methods, or computer program products.

In one embodiment, a first apparatus includes a processor that generates an empty MAC PDU according to an UL CG, the empty MAC PDU free of any MAC SDUs. In one embodiment, the first apparatus includes a transceiver that instructs the physical layer to transmit, to a network, the empty MAC PDU on a HARQ process associated with the UL CG. In one embodiment, the processor prevents autonomous retransmission of the empty MAC PDU to the network.

In one embodiment, a first method generates an empty MAC PDU according to an UL CG, the empty MAC PDU free of any MAC SDUs. In one embodiment, the first method instructs the physical layer to transmit, to a network, the empty MAC PDU on a HARQ process associated with the UL CG. In one embodiment, the first method prevents autonomous retransmission of the empty MAC PDU to the network.

In one embodiment, a second apparatus includes a transceiver that transmits, to a UE, an indication to prevent autonomous retransmissions of empty MAC PDUs for an UL CG, the empty MAC PDUs free of any MAC SDUs and receives, from the UE, the empty MAC PDU on a HARQ process associated with the UL CG.

In one embodiment, a second method transmits, to a UE, an indication to prevent autonomous retransmissions of empty MAC PDUs for an UL CG, the empty MAC PDUs free of any MAC SDUs and receives, from the UE, the empty MAC PDU on a HARQ process associated with the UL CG.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for managing MAC PDU transmissions;

FIG. 2 is a diagram illustrating one embodiment of an NR protocol stack;

FIG. 3 is a block diagram illustrating one embodiment of a user equipment apparatus that may be used for managing MAC PDU transmissions;

FIG. 4 is a block diagram illustrating one embodiment of a network apparatus that may be used for managing MAC PDU transmissions;

FIG. 5 is a flowchart diagram illustrating one embodiment of a method for managing MAC PDU transmissions; and

FIG. 6 is a flowchart diagram illustrating one embodiment of another method for managing MAC PDU transmissions.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of′ includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for managing MAC PDU transmissions. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

In 3GPP NR, the process by which a UE creates a MAC PDU to transmit using the allocated radio resources, e.g., on the uplink, is standardized. This ensures that the UE satisfies the QoS of each configured radio bearer in a way which is optimal and consistent between different UE implementations. Based on the uplink transmission resource grant message signaled on the PDCCH e.g., DCI, the UE decides on the amount of data for each logical channel to be included in the new MAC PDU, and, if necessary, also allocates space for a MAC CE.

In one embodiment, the claimed solution applies to the situation where a MAC would still deliver a MAC PDU with empty uplink (“UL”)-shared channel (“SCH”) (e.g., “padding PDU”) to the physical layer (“PHY”) when it has no higher layer data for uplink transmission, if the configured grant (“CG”) physical uplink shared channel (“PUSCH”) resource overlaps with physical uplink control channel (“PUCCH”). This MAC PDU is solely generated for the purposes of uplink control information (“UCI”) multiplexing in PHY. Since such empty MAC PDUs are stored in the hybrid automatic repeat request (“HARQ”) buffer, the UE would perform some autonomous retransmission of the “empty” MAC PDU under certain conditions, e.g., if the UE cannot receive downlink feedback indicator (“DFI”) until expiration of the configured grant retransmission timer (“CGRT”) corresponding to the HARQ process. However, autonomous retransmissions or retransmissions scheduled by gNB (e.g., DCI-based retransmissions) may not be useful especially when the UCI contents multiplexed in this UCI-only transport block (“TB”) may no longer be useful/valuable for the gNB, since the corresponding information such as HARQ acknowledgement (“HARQ-ACK”) or channel state information (“CSI”) may be already outdated or superseded.

Thus, in conventional methods, the UE would treat an empty MAC PDU, e.g., a MAC PDU that is generated only for UCI multiplexing, the same as any other MAC PDU containing uplink data. Therefore, the UE would, for example, perform some autonomous retransmission, e.g., for NR-U case, or transmit a dynamically scheduled retransmission. This may lead to unnecessary UE power consumption and also create interference for a transmission of a MAC PDU that doesn't contain any useful data.

The solution to the foregoing issue, as described herein, prevents the MAC entity from performing autonomous retransmissions for an empty MAC PDU, which does not contain any MAC service data units (“SDUs”) and may only be comprised of padding/buffer status report (“BSR”). Furthermore, in the claimed solution, the UE ignores a DCI scheduling a retransmission for an “empty” MAC PDU. In one embodiment, the UE flushes the HARQ transmission buffer after the initial transmission of a MAC PDU that contains zero MAC SDUs and is only comprised of padding and/or BSR, e.g. padding BSR. In another embodiment, UCI indicates that a corresponding MAC PDU transmitted on a PUSCH carries no MAC SDUs nor MAC CE(s) except a potential BSR, for the purpose of UCI multiplexing.

In one embodiment, in general, the LCP procedure is applied when a new transmission is performed, e.g., as specified in TS38.321 section 5.4.3. radio resource control (“RRC”) controls the scheduling of uplink data by signaling for each logical channel per MAC entity:
priority where an increasing priority value indicates a lower priority level;
prioritisedBitRate which sets the Prioritized Bit Rate (“PBR”);
bucketSizeDuration which sets the Bucket Size Duration (“BSD”).

RRC additionally controls the LCP procedure by configuring mapping restrictions for each logical channel:
allowedSCS-List which sets the allowed Subcarrier Spacing(s) for transmission;
maxPUSCH-Duration which sets the maximum PUSCH duration allowed for transmission;
configuredGrantType1Allowed which sets whether a configured grant Type 1 can be used for transmission;
allowedServingCells which sets the allowed cell(s) for transmission;
allowedCG-List which sets the allowed configured grant(s) for transmission;
allowedPHY-PriorityIndex which sets the allowed PHY priority index(es) of a dynamic grant for transmission.

The following UE variable is used for the LCP procedure:
Bj, which is maintained for each logical channel j.

The MAC entity shall initialize Bj of the logical channel to zero when the logical channel is established.

For each logical channel j, the MAC entity shall:
increment Bj by the product PBR×T before every instance of the LCP procedure, where T is the time elapsed since Bj was last incremented;
if the value of Bj is greater than the bucket size (i.e., PBR×BSD):
   set Bj to the bucket size.

NOTE: The exact moment(s) when the UE updates Bj between LCP procedures is up to UE implementation, as long as Bj is up to date at the time when a grant is processed by LCP.

For the selection of logical channels, the MAC entity shall, when a new transmission is performed:
select the logical channels for each UL grant that satisfy all the following conditions:
   the set of allowed Subcarrier Spacing index values in allowedSCS-List, if configured, includes the Subcarrier Spacing index associated to the UL grant; and
   maxPUSCH-Duration, if configured, is larger than or equal to the PUSCH transmission duration associated to the UL grant; and
   configuredGrantType1Allowed, if configured, is set to true in case the UL grant is a Configured Grant Type 1; and
   allowedServingCells, if configured, includes the Cell information associated to the UL grant. Does not apply to logical channels associated with a data radio bearer (“DRB”) configured with packet data convergence protocol (“PDCP”) duplication within the same MAC entity (i.e., carrier aggregation (“CA”) duplication) when CA duplication is deactivated for this DRB in this MAC entity; and
   allowedCG-List, if configured, includes the configured grant index associated to the UL grant; and
   allowedPHY-PriorityIndex, if configured, includes the priority index (e.g., as specified in clause 9 of TS 38.213) associated to the dynamic UL grant.

NOTE: The Subcarrier Spacing index, PUSCH transmission duration, Cell information, and priority index are included in Uplink transmission information received from lower layers for the corresponding scheduled uplink transmission.

For the allocation of resources, before the successful completion of the Random Access procedure initiated for dual active protocol stack (“DAPS”) handover, the target MAC entity shall not select the logical channel(s) corresponding to non-DAPS DRB(s) for the uplink grant received in a Random Access Response (“RAR”) or the uplink grant for the transmission of the MsgA payload.

The MAC entity shall, when a new transmission is performed:
allocate resources to the logical channels as follows:
   logical channels selected for the UL grant with Bj>0 are allocated resources in a decreasing priority order. If the PBR of a logical channel is set to infinity, the MAC entity shall allocate resources for all the data that is available for transmission on the logical channel before meeting the PBR of the lower priority logical channel(s);
   decrement Bj by the total size of MAC SDUs served to logical channel j above;
   if any resources remain, all the logical channels selected are served in a strict decreasing priority order (regardless of the value of Bj) until either the data for that logical channel or the UL grant is exhausted, whichever comes first. Logical channels configured with equal priority should be served equally.

NOTE 1: The value of Bj can be negative.

If the MAC entity is requested to simultaneously transmit multiple MAC PDUs, or if the MAC entity receives the multiple UL grants within one or more coinciding PDCCH occasions (i.e., on different Serving Cells), it is up to UE implementation in which order the grants are processed.

The UE shall also follow the rules below during the scheduling procedures above:
the UE should not segment a radio link control (“RLC”) SDU (or partially transmitted SDU or retransmitted RLC PDU) if the whole SDU (or partially transmitted SDU or retransmitted RLC PDU) fits into the remaining resources of the associated MAC entity;
if the UE segments an RLC SDU from the logical channel, it shall maximize the size of the segment to fill the grant of the associated MAC entity as much as possible;
the UE should maximize the transmission of data;
if the MAC entity is given a UL grant size that is equal to or larger than 8 bytes while having data available and allowed for transmission, the MAC entity shall not transmit only padding BSR and/or padding.

The MAC entity shall:
if the MAC entity is configured with enhancedSkipUplinkTxDynamic with value true and the grant indicated to the HARQ entity was addressed to a cell radio network temporary identifier (“C-RNTI”), or if the MAC entity is configured with enhancedSkipUplinkTxConfigured with value true and the grant indicated to the HARQ entity is a configured uplink grant; and
if the MAC entity is not configured with Ich-basedPrioritization; and
if there is no UCI to be multiplexed on this PUSCH transmission, e.g., as specified in TS 38.213; and
if there is no aperiodic CSI requested for this PUSCH transmission, e.g., as specified in TS 38.212; and
if the MAC PDU includes zero MAC SDUs; and
if the MAC PDU includes only the periodic BSR and there is no data available for any logical channel group (“LCG”), or the MAC PDU includes only the padding BSR:
   not generate a MAC PDU for the HARQ entity.
else if the MAC entity is configured with skipUplinkTxDynamic with value true and the grant indicated to the HARQ entity was addressed to a C-RNTI, or the grant indicated to the HARQ entity is a configured uplink grant; and
if there is no aperiodic CSI requested for this PUSCH transmission, e.g., as specified in TS 38.212; and
if the MAC PDU includes zero MAC SDUs; and
if the MAC PDU includes only the periodic BSR and there is no data available for any LCG, or the MAC PDU includes only the padding BSR:
   not generate a MAC PDU for the HARQ entity.

Logical channels shall be prioritized in accordance with the following order (highest priority listed first):
C-RNTI MAC CE or data from UL common control channel (“UL-CCCH”);
Configured Grant Confirmation MAC CE or beam failure recovery (“BFR”) MAC CE or Multiple Entry Configured Grant Confirmation MAC CE;
Sidelink Configured Grant Confirmation MAC CE;
Listen before talk (“LBT”) failure MAC CE;
MAC CE for SL-BSR;
MAC CE for BSR, with exception of BSR included for padding;
Single Entry power headroom report (“PHR”) MAC CE or Multiple Entry PHR MAC CE;
MAC CE for the number of Desired Guard Symbols;
MAC CE for Pre-emptive BSR;
MAC CE for SL-BSR, with exception of SL-BSR and SL-BSR included for padding;
data from any Logical Channel, except data from UL-CCCH;
MAC CE for Recommended bit rate query;
MAC CE for BSR included for padding;
MAC CE for SL-BSR included for padding.

NOTE 2: Prioritization among Configured Grant Confirmation MAC CE, Multiple Entry Configured Grant Confirmation MAC CE, and BFR MAC CE is up to UE implementation.

The MAC entity may prioritize any MAC CE listed in a higher order than data from any Logical Channel, except data from UL-CCCH over transmission of NR sidelink communication.

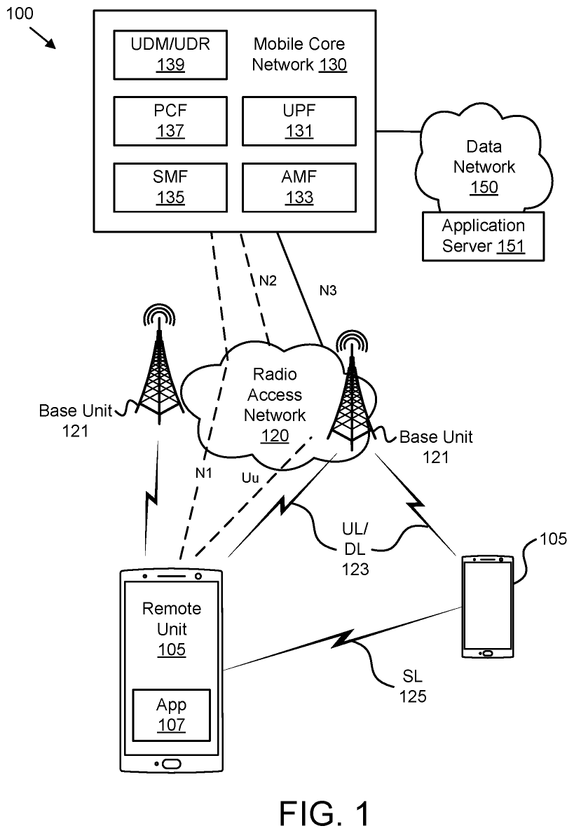

FIG. 1 depicts a wireless communication system 100 supporting CSI enhancements for higher frequencies, according to embodiments of the disclosure. In one embodiment, the wireless communication system 100 includes at least one remote unit 105, a radio access network (“RAN”) 120, and a mobile core network 130. The RAN 120 and the mobile core network 130 form a mobile communication network. The RAN 120 may be composed of a base unit 121 with which the remote unit 105 communicates using wireless communication links 115. Even though a specific number of remote units 105, base units 121, wireless communication links 115, RANs 120, and mobile core networks 130 are depicted in FIG. 1, one of skill in the art will recognize that any number of remote units 105, base units 121, wireless communication links 115, RANs 120, and mobile core networks 130 may be included in the wireless communication system 100.

In one implementation, the RAN 120 is compliant with the 5G system specified in the 3GPP specifications. For example, the RAN 120 may be a New Generation Radio Access Network (“NG-RAN”), implementing NR RAT and/or 3GPP Long-Term Evolution (“LTE”) RAT. In another example, the RAN 120 may include non-3GPP RAT (e.g., Wi-FiR or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802. 16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via UL and downlink (“DL”) communication signals. Furthermore, the UL and DL communication signals may be carried over the wireless communication links 123. Here, the RAN 120 is an intermediate network that provides the remote units 105 with access to the mobile core network 130.

In some embodiments, the remote units 105 communicate with an application server via a network connection with the mobile core network 130. For example, an application 107 (e.g., web browser, media client, telephone and/or Voice-over-Internet-Protocol (“VOIP”) application) in a remote unit 105 may trigger the remote unit 105 to establish a PDU session (or other data connection) with the mobile core network 130 via the RAN 120. The mobile core network 130 then relays traffic between the remote unit 105 and the application server (e.g., the content server 151 in the packet data network 150) using the PDU session. The PDU session represents a logical connection between the remote unit 105 and the User Plane Function (“UPF”) 131.

In order to establish the PDU session (or PDN connection), the remote unit 105 must be registered with the mobile core network 130 (also referred to as “attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5GS”), the term “PDU Session” a data connection that provides end-to-end (“E2E”) user plane (“UP”) connectivity between the remote unit 105 and a specific Data Network (“DN”) through the UPF 131. A PDU Session supports one or more QoS Flows. In certain embodiments, there may be a one-to-one mapping between a QoS Flow and a QoS profile, such that all packets belonging to a specific QOS Flow have the same 5G QoS Identifier (“5Q1”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR-U operation, the base unit 121 and the remote unit 105 communicate over unlicensed radio spectrum.

In one embodiment, the mobile core network 130 is a 5GC or an Evolved Packet Core (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an Access and Mobility Management Function (“AMF”) 133 that serves the RAN 120, a Session Management Function (“SMF”) 135, a Network Exposure Function (“NEF”) 136, a Policy Control Function (“PCF”) 137, a Unified Data Management function (“UDM”) and a User Data Repository (“UDR”).

The UPF(s) 131 is responsible for packet routing and forwarding, packet inspection, QoS handling, and external PDU session for interconnecting Data Network (“DN”), in the 5G architecture. The AMF 133 is responsible for termination of NAS signaling, NAS ciphering & integrity protection, registration management, connection management, mobility management, access authentication and authorization, security context management. The SMF 135 is responsible for session management (i.e., session establishment, modification, release), remote unit (i.e., UE) IP address allocation & management, DL data notification, and traffic steering configuration for UPF for proper traffic routing.

The NEF 136 is responsible for making network data and resources easily accessible to customers and network partners. Service providers may activate new capabilities and expose them through APIs. These APIs allow third-party authorized applications to monitor and configure the network's behavior for a number of different subscribers (i.e., connected devices with different applications). The PCF 137 is responsible for unified policy framework, providing policy rules to CP functions, access subscription information for policy decisions in UDR.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting of the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

While FIG. 1 depicts components of a 5G RAN and a 5G core network, the described embodiments apply to other types of communication networks and RATs, including IEEE 802.11 variants, Global System for Mobile Communications (“GSM”, i.e., a 2G digital cellular network), General Packet Radio Service (“GPRS”), UMTS, LTE variants, CDMA 2000, Bluetooth, ZigBee, Sigfox, and the like.

In the following descriptions, the term “gNB” is used for the base station but it is replaceable by any other radio access node, e.g., RAN node, eNB, Base Station (“BS”), Access Point (“AP”), NR, etc. Further the operations are described mainly in the context of 5G NR. However, the proposed solutions/methods are also equally applicable to other mobile communication systems supporting CSI enhancements for higher frequencies.

The solutions described herein manage MAC PDU transmissions. More specifically, according to the recent agreement in RANI, a CG resource cannot be skipped by the UE if its resource overlaps with a PUCCH.

For instance, for the case where one or more CG PUSCHs overlap with PUCCH, for CA and non-CA case, when logical channel (“LCH”) based prioritization is not configured and there is a single PHY priority for UL transmissions, and when PUSCH repetition is not applied, in case of one or more CG PUSCHs overlapping with UCI and there is no dynamic grant (“DG”) PUSCH overlapping with the UCI and there is no DG PUSCH overlapping with the one or more CG PUSCHs, the CG PUSCH with UCI multiplexing from the one or more CG PUSCHs cannot be skipped. MAC generates MAC PDU for the CG PUSCH and delivers the MAC PDU to PHY and the UCI is multiplexed on the CG PUSCH.

Moreover, to accommodate the foregoing, the MAC entity shall:
if the MAC entity is configured with enhancedSkipUplinkTxDynamic with value true and the grant indicated to the HARQ entity was addressed to a C-RNTI, or if the MAC entity is configured with enhancedSkipUplinkTxConfigured with value true and the grant indicated to the HARQ entity is a configured uplink grant; and
if the MAC entity is not configured with Ich-basedPrioritization; and
if there is no UCI to be multiplexed on this PUSCH transmission, e.g., as specified in TS 38.213; and
if there is no aperiodic CSI requested for this PUSCH transmission, e.g., as specified in TS 38.212; and
if the MAC PDU includes zero MAC SDUs; and
if the MAC PDU includes only the periodic BSR and there is no data available for any LCG, or the MAC PDU includes only the padding BSR:
   not generate a MAC PDU for the HARQ entity.

Based on the above, it is apparent that the MAC would still deliver to PHY a MAC PDU with empty UL-SCH (“padding PDU”) when it has no data for uplink transmission and when the CG PUSCH resource overlaps with PUCCH. This MAC PDU is solely generated for the purposes of UCI multiplexing in PHY.

When such a TB is generated by MAC, it is also stored in one of the HARQ processes. And if the UE cannot receive DFI until expiration of CGRT corresponding to the HARQ process, the UE would consider this TB as a “retransmission” when selecting HARQ process for a subsequent CG resource. However autonomous retransmissions or retransmissions scheduled by gNB (e.g., DCI-based retransmissions) may not be useful especially when the UCI contents multiplexed in this UCI-only TB may be no longer useful/valuable for the gNB, since the corresponding information, such as HARQ-ACK or CSI, may be already outdated or superseded.

Throughout the disclosure, the term “empty MAC PDU” refers to the case where the UE generates a MAC PDU/TB that does not contain any data of a configured DRB/SRB, i.e., zero MAC SDUs. Furthermore the “empty MAC PDU/TB” may be only comprised of padding and/or a padding BSR MAC CE. Alternatively, the empty MAC PDU/TB may only include a periodic BSR and there is no data available for any LCG.

According to one embodiment, a UE does not perform autonomous retransmission(s) for cases when the TB to be autonomously (re)transmitted on PUSCH is an “empty MAC PDU/TB,” e.g., carrying no data of DRB(s)/signaling radio bearers (“SRBs”) for uplink transmission, e.g., zero MAC SDUs. The assumption for this embodiment is that this MAC PDU is solely generated for the purposes of UCI multiplexing in PHY, e.g., UCI multiplexed on the PUSCH. MAC would still deliver to PHY such MAC PDU with empty UL-SCH, e.g., MAC PDU is only comprised of padding and/or padding BSR, when the CG PUSCH resource overlaps with PUCCH.

According to one implementation of this embodiment, a UE operating in a shared spectrum does not perform an autonomous retransmission of an “empty” MAC PDU/TB carrying UCI-only for cases when no DFI has been received until expiration of cg-RetransmissionTimer CGRT corresponding to the HARQ process. According to one further aspect of this embodiment, the UE may flush the HARQ buffer upon expiration of the cg-RetransmissionTimer. The UE does not deliver the configured uplink grant and the associated HARQ information to the HARQ entity.

According to one further implementation of this embodiment, the UE flushes the HARQ buffer after the initial transmission or transmission attempt of an empty MAC PDU, e.g., MAC PDU is comprised of zero MAC SDU(s) and only padding/padding BSR is contained in the MAC PDU. In an implementation of the embodiment, the behavior of a UE flushing the HARQ buffer after the first transmission of an empty MAC PDU carrying only UCI is configurable by the gNB/NW. The UE behavior would be similar to the case that the UE skips an UL transmission due to no data availability. For cases when the UE did not have data available at initial transmission while there was also no overlapping UCI, the initial transmission gets skipped as part of the normal UL skipping procedure and MAC does not create a MAC PDU for the UL grant. Per the current procedure, MAC flushes the HARQ buffer in this case. According to this implementation of the embodiment, MAC flushes the HARQ buffer also for the case that MAC generated an empty MAC PDU just for the purpose of UCI multiplexing.

According to one further implementation of the embodiment, the UE skips uplink retransmissions of MAC PDUs for cases when the MAC PDU contains only padding and/or BSR and zero MAC SDUs. In one specific implementation the parameter/IE enhancedSkipUplinkTxDynamic or enhancedSkipUplinkTxConfigured configures whether the UE shall or is allowed to skip also HARQ retransmissions for cases when the MAC PDU is a padding PDU containing zero MAC SDUs. Alternatively a new parameter/information element (“IE”) is introduced that configures whether the UE shall or is allowed to skip HARQ retransmission(s) of empty padding MAC PDUs.

According to one implementation of the embodiment, the UE doesn't start the configuredGrantTimer and/or cg-RetransmissionTimer upon having performed the transmission on CG PUSCH for cases when the MAC PDU transmitted on the CG PUSCH is empty, e.g., MAC PDU doesn't contain any uplink data (DRB/SRB), e.g., zero MAC SDU(s), but only padding and was soley generated for the purpose of UCI-multiplexing.

According to one implementation of the embodiment, the UE performs an autonomous retransmission of an “empty” MAC PDU that has been only generated for the purpose of UCI-multiplexing for cases when the autonomous retransmission was triggered by an LBT failure, i.e. “empty” MAC PDU was not transmitted due to LBT failure. The motivation to perform the autonomous retransmission for the cases of LBT failure is that UCI has not been transmitted at all before. According to one implementation aspect of this embodiment, the autonomous retransmission may be deprioritized over other potential initial transmission when doing the HARQ process selection.

According to some alternative implementations of this embodiment, the UE does not perform an autonomous retransmission triggered by LBT failure for cases when the corresponding TB/MAC PDU is an “empty” PDU, e.g., only containing padding and solely generated for the purpose of UCI-multiplexing. According to one specific implementation the UE does not consider the corresponding HARQ process as pending (upon having received a notification of an LBT failure from PHY) for cases when the TB does not contain any MAC SDUs or any MAC CE(s) except e.g., a padding BSR, e.g., MAC PDU is only generated for the purpose of UCI-multiplexing.

According to one implementation of this embodiment, the UE behavior with respect to performing autonomous retransmission for an empty MAC PDU/TB depends on the content of the UCI that is multiplexed to the PUSCH. For example, for cases when the UCI is comprised of HARQ ACK/NACK information, the UE may perform autonomous retransmissions whereas when the UCI is comprised of CSI information the UE may not support autonomous retransmissions of the empty MAC PDU/TB.

Some exemplary specifications/implementations of the embodiment, e.g., in TS38.321, are provided below:

### Option 1

For each Serving Cell and each configured uplink grant, if configured and activated, the MAC entity shall:
1> if the MAC entity is configured with Ich-basedPrioritization, and the PUSCH duration of the configured uplink grant does not overlap with the PUSCH duration of an uplink grant received in a Random Access Response or with the PUSCH duration of an uplink grant addressed to Temporary C-RNTI or the PUSCH duration of a MSGA payload for this Serving Cell; or
1> if the MAC entity is not configured with Ich-basedPrioritization, and the PUSCH duration of the configured uplink grant does not overlap with the PUSCH duration of an uplink grant received on the PDCCH or in a Random Access Response or the PUSCH duration of a MSGA payload for this Serving Cell:
   2> set the HARQ Process ID to the HARQ Process ID associated with this PUSCH duration;
   2> if, for the corresponding HARQ process, the configuredGrantTimer is not running and cg-RetransmissionTimer is not configured (i.e. new transmission):
      3> consider the new data indicator (“NDI”) bit for the corresponding HARQ process to have been toggled:
      3> deliver the configured uplink grant and the associated HARQ information to the HARQ entity.
   2> else if the cg-RetransmissionTimer for the corresponding HARQ process is configured and not running, then for the corresponding HARQ process:
      3> if the configuredGrantTimer is not running, and the HARQ process is not pending (i.e. new transmission):
         4> consider the NDI bit to have been toggled:
         4> deliver the configured uplink grant and the associated HARQ information to the HARQ entity.
      3> else if the previous uplink grant delivered to the HARQ entity for the same HARQ process was a configured uplink grant (i.e. retransmission on configured grant):
         4> if the MAC PDU obtained for this HARQ process contains one or more MAC SDUs and/or if the MAC PDU contains not only a padding BSR
         5> deliver the configured uplink grant and the associated HARQ information to the HARQ entity.

### Option 2

The MAC entity includes a HARQ entity for each Serving Cell with configured uplink (including the case when it is configured with supplementaryUplink), which maintains a number of parallel HARQ processes. The number of parallel UL HARQ processes per HARQ entity is specified in TS 38.214. Each HARQ process supports one TB. Each HARQ process is associated with a HARQ process identifier. For UL transmission with UL grant in RA Response or for UL transmission for MSGA payload, HARQ process identifier 0 is used.

NOTE: When a single DCI is used to schedule multiple PUSCH, the UE is allowed to map generated TB(s) internally to different HARQ processes in case of LBT failure(s), e.g., UE may transmit a new TB on any HARQ process in the grants that have the same transport block size (“TBS”), the same redundancy version (“RV”) and the NDIs indicate new transmission.

The maximum number of transmissions of a TB within a bundle of the dynamic grant or configured grant is given by REPETITION_NUMBER as follows:
For a dynamic grant, REPETITION_NUMBER is set to a value provided by lower layers, e.g., as specified in clause 6.1.2.1 of TS 38.214;
For a configured grant, REPETITION_NUMBER is set to a value provided by lower layers, e.g., as specified in clause 6.1.2.3 of TS 38.214.

If REPETITION_NUMBER>1, after the first transmission within a bundle, at most REPETITION_NUMBER−1 HARQ retransmissions follow within the bundle. For both dynamic grant and configured uplink grant, bundling operation relies on the HARQ entity for invoking the same HARQ process for each transmission that is part of the same bundle. Within a bundle, HARQ retransmissions are triggered without waiting for feedback from previous transmission according to REPETITION_NUMBER for a dynamic grant or configured uplink grant unless they are terminated e.g., as specified in clause 6.1 of TS 38.214. Each transmission within a bundle is a separate uplink grant delivered to the HARQ entity.

For each transmission within a bundle of the dynamic grant, the sequence of redundancy versions may be determined according to clause 6.1.2.1 of TS 38.214. For each transmission within a bundle of the configured uplink grant, the sequence of redundancy versions may be determined according to clause 6.1.2.3 of TS 38.214.

For each uplink grant, the HARQ entity shall:
1> identify the HARQ process associated with this grant, and for each identified HARQ process:
   2> if the received grant was not addressed to a Temporary C-RNTI on PDCCH, and the NDI provided in the associated HARQ information has been toggled compared to the value in the previous transmission of this TB of this HARQ process: or
   2> if the uplink grant was received on PDCCH for the C-RNTI and the HARQ buffer of the identified process is empty: or
   2> if the uplink grant was received in a Random Access Response (e.g., in a MAC RAR or a fallback RAR); or
   2> if the uplink grant was determined for the transmission of the MSGA payload: or
   2> if the uplink grant was received on PDCCH for the C-RNTI in ra-Response Window and this PDCCH successfully completed the Random Access procedure initiated for beam failure recovery; or
   2> if the uplink grant is part of a bundle of the configured uplink grant, and may be used for initial transmission, e.g., according to clause 6.1.2.3 of TS 38.214, and if no MAC PDU has been obtained for this bundle:
      3> if there is a MAC PDU in the MSGA buffer and the uplink grant determined for the transmission of the MSGA payload was selected; or
      3> if there is a MAC PDU in the MSGA buffer and the uplink grant was received in a fallbackRAR and this fallbackRAR successfully completed the Random Access procedure:
         4> obtain the MAC PDU to transmit from the MSGA buffer.
      3> else if there is a MAC PDU in the Msg3 buffer and the uplink grant was received in a fallbackRAR:
         4> obtain the MAC PDU to transmit from the Msg3 buffer.
      3> else if there is a MAC PDU in the Msg3 buffer and the uplink grant was received in a MAC RAR: or:
      3> if there is a MAC PDU in the Msg3 buffer and the uplink grant was received on PDCCH for the C-RNTI in ra-Response Window and this PDCCH successfully completed the Random Access procedure initiated for beam failure recovery:
         4> obtain the MAC PDU to transmit from the Msg3 buffer.
         4> if the uplink grant size does not match with size of the obtained MAC PDU; and
         4> if the Random Access procedure was successfully completed upon receiving the uplink grant:
         5> indicate to the Multiplexing and assembly entity to include MAC subPDU(s) carrying MAC SDU from the obtained MAC PDU in the subsequent uplink transmission;
         5> obtain the MAC PDU to transmit from the Multiplexing and assembly entity.
      3> else if this uplink grant is a configured grant configured with autonomousTx; and
      3> if the previous configured uplink grant, in the bandwidth part (“BWP”), for this HARQ process was not prioritized; and
      3> if a MAC PDU had already been obtained for this HARQ process; and
      3> if the uplink grant size matches with size of the obtained MAC PDU; and
      3> if none of PUSCH transmission(s) of the obtained MAC PDU has been completely performed:
         4> consider the MAC PDU has been obtained.
      3> else if the MAC entity is not configured with Ich-basedPrioritization; or
      3> if this uplink grant is a prioritized uplink grant:
         4> obtain the MAC PDU to transmit from the Multiplexing and assembly entity, if any:
      3> if a MAC PDU to transmit has been obtained:
         4> if the uplink grant is not a configured grant configured with autonomousTx: or
         4> if the uplink grant is a prioritized uplink grant:
         5> deliver the MAC PDU and the uplink grant and the HARQ information of the TB to the identified HARQ process:
         5> instruct the identified HARQ process to trigger a new transmission:
         5> if the uplink grant is a configured uplink grant:
         6> start or restart the configuredGrantTimer, if configured, for the corresponding HARQ process when the transmission is performed if LBT failure indication is not received from lower layers:
         6> start or restart the cg-RetransmissionTimer, if configured, for the corresponding HARQ process when the transmission is performed if LBT failure indication is not received from lower layers.
         5> if the uplink grant is addressed to C-RNTI, and the identified HARQ process is configured for a configured uplink grant:
         6> start or restart the configuredGrantTimer, if configured, for the corresponding HARQ process when the transmission is performed if LBT failure indication is not received from lower layers.
         > if cg-RetransmissionTimer is configured for the identified HARQ process; and
         5> if the transmission is performed and LBT failure indication is received from lower layers:
         > consider the identified HARQ process as pending.
      3> else:
         4> flush the HARQ buffer of the identified HARQ process.
   2> else (i.e., retransmission):
      3> if the uplink grant received on PDCCH was addressed to CS-RNTI and if the HARQ buffer of the identified process is empty: or
      3> if the uplink grant is part of a bundle and if no MAC PDU has been obtained for this bundle: or
      3> if the uplink grant is part of a bundle of the configured uplink grant, and the PUSCH duration of the uplink grant overlaps with a PUSCH duration of another uplink grant received on the PDCCH or an uplink grant received in a Random Access Response (e.g., MAC RAR or fallbackRAR) or an uplink grant determined for MSGA payload for this Serving Cell: or:
      3> if the MAC entity is configured with Ich-basedPrioritization and this uplink grant is not a prioritized uplink grant:
         4> ignore the uplink grant.
      3> else:
         > deliver the uplink grant and the HARQ information (redundancy version) of the TB to the identified HARQ process:
         4> if the TB of the identified HARQ process contains one or more MAC SDUs and/or if the MAC PDU contains not only a padding BSR
         5> instruct the identified HARQ process to trigger a retransmission;
         5> if the uplink grant is addressed to CS-RNTI: or
         5> if the uplink grant is addressed to C-RNTI, and the identified HARQ process is configured for a configured uplink grant:
         6> start or restart the configuredGrantTimer, if configured, for the corresponding HARQ process when the transmission is performed if LBT failure indication is not received from lower layers.
         5> if the uplink grant is a configured uplink grant:
         6> if the identified HARQ process is pending:
         7> start or restart the configuredGrantTimer, if configured, for the corresponding HARQ process when the transmission is performed if LBT failure indication is not received from lower layers:
         6> start or restart the cg-RetransmissionTimer, if configured, for the corresponding HARQ process when the transmission is performed if LBT failure indication is not received from lower layers.
         5> if the identified HARQ process is pending and the transmission is performed and LBT failure indication is not received from lower layers:
         6> consider the identified HARQ process as not pending.

### Option 3

The MAC entity includes a HARQ entity for each Serving Cell with configured uplink (including the case when it is configured with supplementaryUplink), which maintains a number of parallel HARQ processes. The number of parallel UL HARQ processes per HARQ entity is specified in TS 38.214. Each HARQ process supports one TB. Each HARQ process is associated with a HARQ process identifier. For UL transmission with UL grant in RA Response or for UL transmission for MSGA payload, HARQ process identifier 0 is used.

NOTE: When a single DCI is used to schedule multiple PUSCH, the UE is allowed to map generated TB(s) internally to different HARQ processes in case of LBT failure(s), i.e., UE may transmit a new TB on any HARQ process in the grants that have the same TBS, the same RV and the NDIs indicate new transmission.

The maximum number of transmissions of a TB within a bundle of the dynamic grant or configured grant is given by REPETITION_NUMBER as follows:
For a dynamic grant, REPETITION_NUMBER is set to a value provided by lower layers, e.g., as specified in clause 6.1.2.1 of TS 38.214;
For a configured grant, REPETITION_NUMBER is set to a value provided by lower layers, e.g., as specified in clause 6.1.2.3 of TS 38.214.

If REPETITION_NUMBER>1, after the first transmission within a bundle, at most REPETITION_NUMBER−1 HARQ retransmissions follow within the bundle. For both dynamic grant and configured uplink grant, bundling operation relies on the HARQ entity for invoking the same HARQ process for each transmission that is part of the same bundle. Within a bundle, HARQ retransmissions are triggered without waiting for feedback from previous transmission according to REPETITION_NUMBER for a dynamic grant or configured uplink grant unless they are terminated e.g., as specified in clause 6.1 of TS 38.214. Each transmission within a bundle is a separate uplink grant delivered to the HARQ entity.

For each transmission within a bundle of the dynamic grant, the sequence of redundancy versions is determined according to clause 6.1.2.1 of TS 38.214. For each transmission within a bundle of the configured uplink grant, the sequence of redundancy versions is determined according to clause 6.1.2.3 of TS 38.214.

For each uplink grant, the HARQ entity shall:
1> identify the HARQ process associated with this grant, and for each identified HARQ process:
   2> if the received grant was not addressed to a Temporary C-RNTI on PDCCH, and the NDI provided in the associated HARQ information has been toggled compared to the value in the previous transmission of this TB of this HARQ process: or
   2> if the uplink grant was received on PDCCH for the C-RNTI and the HARQ buffer of the identified process is empty: or
   2> if the uplink grant was received in a Random Access Response (e.g., in a MAC RAR or a fallback RAR): or
   2> if the uplink grant was determined for the transmission of the MSGA payload: or
   2> if the uplink grant was received on PDCCH for the C-RNTI in ra-Response Window and this PDCCH successfully completed the Random Access procedure initiated for beam failure recovery: or
   2> if the uplink grant is part of a bundle of the configured uplink grant, and may be used for initial transmission, e.g., according to clause 6.1.2.3 of TS 38.214, and if no MAC PDU has been obtained for this bundle:
      3> if there is a MAC PDU in the MSGA buffer and the uplink grant determined for the transmission of the MSGA payload was selected: or
      3> if there is a MAC PDU in the MSGA buffer and the uplink grant was received in a fallbackRAR and this fallbackRAR successfully completed the Random Access procedure:
         4> obtain the MAC PDU to transmit from the MSGA buffer.
      3> else if there is a MAC PDU in the Msg3 buffer and the uplink grant was received in a fallbackRAR:
         4> obtain the MAC PDU to transmit from the Msg3 buffer.
      3> else if there is a MAC PDU in the Msg3 buffer and the uplink grant was received in a MAC RAR: or:
      3> if there is a MAC PDU in the Msg3 buffer and the uplink grant was received on PDCCH for the C-RNTI in ra-Response Window and this PDCCH successfully completed the Random Access procedure initiated for beam failure recovery:
         4> obtain the MAC PDU to transmit from the Msg3 buffer.
         4> if the uplink grant size does not match with size of the obtained MAC PDU; and
         4> if the Random Access procedure was successfully completed upon receiving the uplink grant:
         5> indicate to the Multiplexing and assembly entity to include MAC subPDU(s) carrying MAC SDU from the obtained MAC PDU in the subsequent uplink transmission:
         5> obtain the MAC PDU to transmit from the Multiplexing and assembly entity.
      3> else if this uplink grant is a configured grant configured with autonomousTx; and
      3> if the previous configured uplink grant, in the BWP, for this HARQ process was not prioritized; and
      3> if a MAC PDU had already been obtained for this HARQ process; and
      3> if the uplink grant size matches with size of the obtained MAC PDU; and
      3> if none of PUSCH transmission(s) of the obtained MAC PDU has been completely performed:
         4> consider the MAC PDU has been obtained.
      3> else if the MAC entity is not configured with Ich-basedPrioritization; or
      3> if this uplink grant is a prioritized uplink grant:
         4> obtain the MAC PDU to transmit from the Multiplexing and assembly entity, if any:
      3> if a MAC PDU to transmit has been obtained:
         4> if the uplink grant is not a configured grant configured with autonomousTx: or
         4> if the uplink grant is a prioritized uplink grant:
         5> deliver the MAC PDU and the uplink grant and the HARQ information of the TB to the identified HARQ process:
         5> instruct the identified HARQ process to trigger a new transmission:
         5> if the uplink grant is a configured uplink grant:
         6> start or restart the configuredGrantTimer, if configured, for the corresponding HARQ process when the transmission is performed if LBT failure indication is not received from lower layers:
         6> start or restart the cg-RetransmissionTimer, if configured, for the corresponding HARQ process when the transmission is performed if LBT failure indication is not received from lower layers.
         > if the MAC PDU contains zero MAC SDUs and/or only a padding BSR
         7> flush the HARQ buffer of the identified HARQ process.
         5> if the uplink grant is addressed to C-RNTI, and the identified HARQ process is configured for a configured uplink grant:
         6> start or restart the configuredGrantTimer, if configured, for the corresponding HARQ process when the transmission is performed if LBT failure indication is not received from lower lavers.
         5> if cg-RetransmissionTimer is configured for the identified HARQ process; and
         5> if the transmission is performed and LBT failure indication is received from lower layers:
         6> consider the identified HARQ process as pending.
      3> else:
         4> flush the HARQ buffer of the identified HARQ process.
   2> else (e.g., retransmission):
      3> if the uplink grant received on PDCCH was addressed to CS-RNTI and if the HARQ buffer of the identified process is empty; or
      3> if the uplink grant is part of a bundle and if no MAC PDU has been obtained for this bundle: or
      3> if the uplink grant is part of a bundle of the configured uplink grant, and the PUSCH duration of the uplink grant overlaps with a PUSCH duration of another uplink grant received on the PDCCH or an uplink grant received in a Random Access Response (i.e., MAC RAR or fallbackRAR) or an uplink grant determined for MSGA payload for this Serving Cell: or:
      3> if the MAC entity is configured with Ich-basedPrioritization and this uplink grant is not a prioritized uplink grant:
         4> ignore the uplink grant.

According to one embodiment, the UE ignores a DCI scheduling a retransmission of a TB/PUSCH transmission carrying only UCI. For cases when a UE receives a DCI addressed to the CS-RNTI scheduling a retransmission of a MAC PDU which carries no uplink data (DRB/SRB) but only e.g., padding, i.e., the MAC PDU was solely generated for the purpose of UCI-multiplexing, the UE ignores according to this embodiment the DCI and does not perform a retransmission. According to one implementation of the embodiment, the UE flushes the HARQ buffer upon having transmitted a MAC PDU on a CG PUSCH resource which carries no data of a DRB/SRB (zero MAC SDU), e.g., carrying only padding information and/or padding BSR. Since the HARQ buffer is empty, UE will for the case of receiving a retransmission DCI ignore such uplink grant.

In an implementation of the embodiment, the behavior of a UE ignoring a DCI scheduling a retransmission of a TB/PUSCH transmission carrying only UCI is configurable. In one specific implementation the parameter/IE enhancedSkipUplinkTxDynamic or enhancedSkipUplinkTxConfigured configures whether the UE shall ignore DCIs scheduling an retransmission of a padding MAC PDU containing zero MAC SDUs. Alternatively a new parameter/IE is introduced which configures whether the UE shall ignore the retransmission grants:
2> else (i.e., retransmission):
   3> if the uplink grant received on PDCCH was addressed to CS-RNTI and if the HARQ buffer of the identified process is empty: or
   3> if the uplink grant is part of a bundle and if no MAC PDU has been obtained for this bundle: or
   3> if the uplink grant is part of a bundle of the configured uplink grant, and the PUSCH duration of the uplink grant overlaps with a PUSCH duration of another uplink grant received on the PDCCH or an uplink grant received in a Random Access Response (i.e., MAC RAR or fallbackRAR) or an uplink grant determined for MSGA payload for this Serving Cell; or:
   3> if the MAC entity is configured with Ich-basedPrioritization and this uplink grant is not a prioritized uplink grant:
      4> ignore the uplink grant.

According to one embodiment, UCI explicitly indicates that a corresponding MAC PDU transmitted on a PUSCH carries no MAC SDUs nor MAC CE(s) except a potential padding BSR. According to one implementation the uplink control information is the CG-UCI transmitted along with a MAC PDU on a CG PUSCH. For operation in a shared spectrum the CG-UCI may be transmitted with every CG PUSCH transmission. It is comprised of information such as HARQ related information (e.g., HARQ process ID, NDI) and Channel Occupancy Time (“COT”) sharing information. According to one implementation of this embodiment, a new information field in the CG-UCI indicates that the corresponding MAC PDU transmitted on the CG PUSCH is an empty TB, e.g., MAC PDU is comprised of padding and is solely generated for the purpose of UCI multiplexing.

TABLE 1
Mapping order of CG-UCI fields

| Field | Bitwidth |
|---|---|
| HARQ process number | 4 |
| Redundancy version | 2 |
| New data indicator | 1 |
| Channel Occupancy | ┌log₂C┐ if both higher layer parameter |
| Time (COT) sharing | ULtoDL-CO-SharingED-Threshold-r16 |
| information | and higher layer parameter cg-COT- |
| | SharingList-r16 are configured, where |
| | C is the number of combinations |
| | configured in cg-COT-SharingList-r16; |
| | 1 if higher layer parameter ULtoDL- |
| | CO-SharingED-Threshold-r16 is not |
| | configured and higher layer parameter |
| | cg-COT-SharingOffset-r16 is |
| | configured; |
| | 0 otherwise; |
| | If a UE indicates COT sharing other |
| | than “no sharing” in a CG PUSCH |
| | within the UE's initiated COT, the UE |
| | should provide consistent COT sharing |
| | information in all the subsequent CG |
| | PUSCHs, if any, occurring within the |
| | same UE's initiated COT such that the |
| | same DL starting point and duration are |
| | maintained. |

In an implementation of the embodiment, the behavior of a UE indicating that a corresponding MAC PDU transmitted on a PUSCH carries no MAC SDUs nor MAC CE(s) except a potential padding BSR, is configurable.

According to one embodiment, the priority of a MAC PDU carrying no MAC SDUs nor MAC CEs (except BSR/MAC CE) is considered as the lowest priority for any prioritizations. According to one implementation of this embodiment, the UE uses the prioritization rules defined for URLLC (Rel-16) for the HARQ process selection. Even though for NR-U in Rel-16 it was specified that UE shall prioritize retransmissions over initial transmission, in one embodiment, the UE uses the priority of an UL grant/MAC PDU when selecting a HARQ process, e.g., determining whether to perform a HARQ retransmission or an initial transmission on a CG PUSCH. The priority of an uplink grant is determined by the highest priority among priorities of the logical channels that are multiplexed (e.g., the MAC PDU to transmit is already stored in the HARQ buffer) or have data available that can be multiplexed (e.g., the MAC PDU to transmit is not stored in the HARQ buffer) in the MAC PDU, according to the mapping restrictions, e.g., as described in clause 5.4.3.1.2 of TS38.321.

According to one implementation of this embodiment, the UE shall deprioritize the (re)transmission of a MAC PDU which has no uplink data (e.g., SRB/DRB) and contains only padding, e.g., the UE solely generated for the purpose of UCI-multiplexing. According to another implementation of this embodiment, the UE prioritizes an initial transmission of an “empty” TB carrying UCI-only information on the PUSCH over an autonomous retransmission. To transmit the UCI information immediately, the UE shall delay an autonomous retransmission that is competing for the transmission (e.g., HARQ process selection) and rather transmit the “empty” TB containing no higher layer UL data, but only the UCI multiplexed on the PUSCH.

According to another embodiment, the UE shall not start the drx-HARQ-RTT-TimerUL for the corresponding HARQ process upon having transmitted a MAC PDU in a configured uplink grant if the MAC PDU is an “empty MAC PDU” containing only padding and/or padding BSR and zero MAC SDUs. By not starting the drx-HARQ-RTT-TimerUL timer, the UE will not go to ActiveTime, e.g., after expiry of drx-HARQ-RTT-TimerUL, and monitor PDCCH for any retransmission grants. Hence a further power saving benefit can be achieved by this embodiment.

An exemplary implementation of the embodiment, e.g., in TS38.321 is given in the following:
1> if a MAC PDU is transmitted in a configured uplink grant and LBT failure indication is not received from lower layers:
   2> if the MAC PDU contains one or more MAC SDUs or if the MAC PDU contains not only padding and/or padding BSR
      3> start the drx-HARQ-RTT-TimerUL for the corresponding HARQ process in the first symbol after the end of the first transmission (within a bundle) of the corresponding PUSCH transmission:
      3> stop the drx-RetransmissionTimerUL for the corresponding HARQ process at the first transmission (within a bundle) of the corresponding PUSCH transmission.

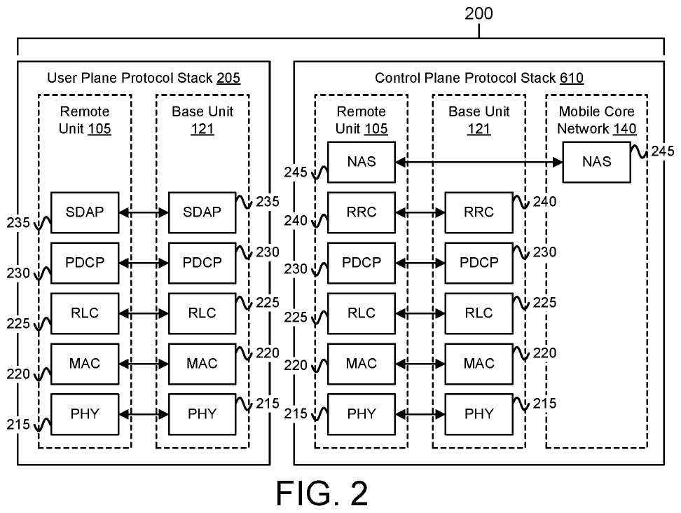

FIG. 2 depicts a NR protocol stack 200, according to embodiments of the disclosure. While FIG. 2 shows the remote unit 105, the base unit 121 and the mobile core network 130, these are representative of a set of UEs interacting with a RAN node and a NF (e.g., AMF) in a core network. As depicted, the protocol stack 200 comprises a User Plane protocol stack 205 and a Control Plane protocol stack 210. The User Plane protocol stack 205 includes a PHY layer 215, a MAC sublayer 220, a Radio Link Control (“RLC”) sublayer 225, a PDCP sublayer 230, and a Service Data Adaptation Protocol (“SDAP”) sublayer 235. The Control Plane protocol stack 210 also includes a PHY layer 215, a MAC sublayer 220, a RLC sublayer 225, and a PDCP sublayer 230. The Control Plane protocol stack 210 also includes an RRC layer and a Non-Access Stratum (“NAS”) layer 245.

The AS protocol stack for the Control Plane protocol stack 210 consists of at least RRC, PDCP, RLC and MAC sublayers, and the PHY layer. The AS protocol stack for the User Plane protocol stack 205 consists of at least SDAP. PDCP, RLC and MAC sublayers, and the PHY layer. The Layer-2 (“L2”) is split into the SDAP, PDCP, RLC and MAC sublayers. The Layer-3 (“L3”) includes the RRC sublayer 240 and the NAS layer 245 for the control plane and includes, e.g., an Internet Protocol (“IP”) layer or PDU Layer (not depicted) for the user plane. L1 and L2 are referred to as “lower layers” such as PUCCH/PUSCH or MAC CE, while L3 and above (e.g., transport layer, application layer) are referred to as “higher layers” or “upper layers” such as RRC.

The physical layer 215 offers transport channels to the MAC sublayer 220. The MAC sublayer 220 offers logical channels to the RLC sublayer 225. The RLC sublayer 225 offers RLC channels to the PDCP sublayer 230. The PDCP sublayer 230 offers radio bearers to the SDAP sublayer 235 and/or RRC sublayer 240. The SDAP sublayer 235 offers QoS flows to the mobile core network 130 (e.g., 5GC). The RRC sublayer 240 provides for the addition, modification, and release of Carrier Aggregation and/or Dual Connectivity. The RRC sublayer 240 also manages the establishment, configuration, maintenance, and release of SRBs and DRBs.

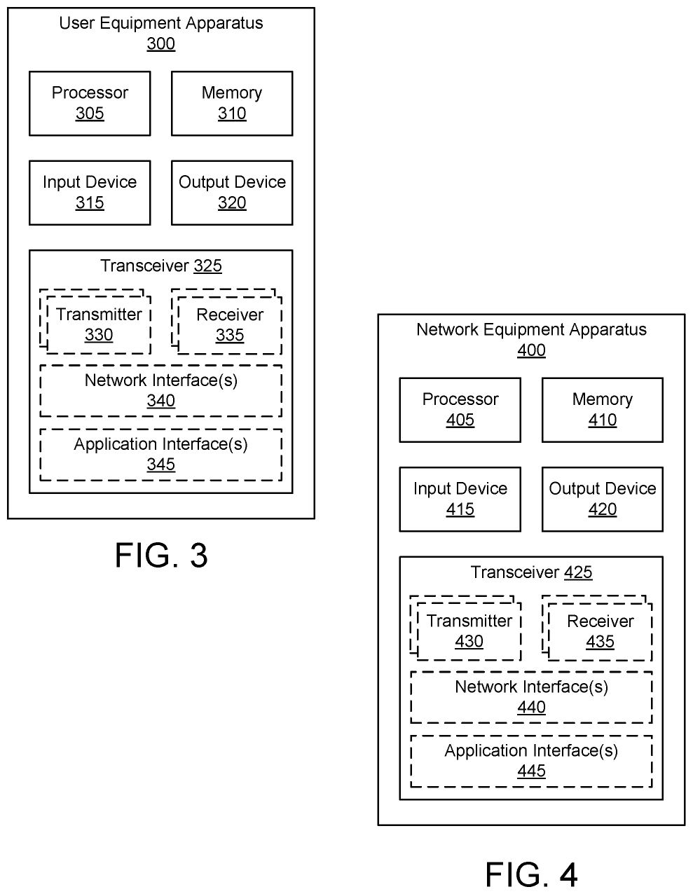

FIG. 3 depicts a user equipment apparatus 300 that may be used for managing MAC PDU transmissions, according to embodiments of the disclosure. In various embodiments, the user equipment apparatus 300 is used to implement one or more of the solutions described above. The user equipment apparatus 300 may be one embodiment of a UE, such as the remote unit 105 and/or the UE 205, as described above. Furthermore, the user equipment apparatus 300 may include a processor 305, a memory 310, an input device 315, an output device 320, and a transceiver 325. In some embodiments, the input device 315 and the output device 320 are combined into a single device, such as a touchscreen. In certain embodiments, the user equipment apparatus 300 may not include any input device 315 and/or output device 320. In various embodiments, the user equipment apparatus 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more base units 121. Additionally, the transceiver 325 may support at least one network interface 340 and/or application interface 345. The application interface(s) 345 may support one or more APIs. The network interface(s) 340 may support 3GPP reference points, such as Uu and PC5. Other network interfaces 340 may be supported, as understood by one of ordinary skill in the art.

The processor 305, in one embodiment, may include any known controller capable of executing computer-readable instructions and/or capable of performing logical operations. For example, the processor 305 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 305 executes instructions stored in the memory 310 to perform the methods and routines described herein. The processor 305 is communicatively coupled to the memory 310, the input device 315, the output device 320, and the transceiver 325. In certain embodiments, the processor 305 may include an application processor (also known as “main processor”) which manages application-domain and operating system (“OS”) functions and a baseband processor (also known as “baseband radio processor”) which manages radio functions.

The memory 310, in one embodiment, is a computer readable storage medium. In some embodiments, the memory 310 includes volatile computer storage media. For example, the memory 310 may include a RAM, including dynamic RAM (“DRAM”), synchronous dynamic RAM (“SDRAM”), and/or static RAM (“SRAM”). In some embodiments, the memory 310 includes non-volatile computer storage media. For example, the memory 310 may include a hard disk drive, a flash memory, or any other suitable non-volatile computer storage device. In some embodiments, the memory 310 includes both volatile and non-volatile computer storage media.

In some embodiments, the memory 310 stores data related to CSI enhancements for higher frequencies. For example, the memory 310 may store parameters, configurations, resource assignments, policies, and the like as described above. In certain embodiments, the memory 310 also stores program code and related data, such as an operating system or other controller algorithms operating on the user equipment apparatus 300, and one or more software applications.

The input device 315, in one embodiment, may include any known computer input device including a touch panel, a button, a keyboard, a stylus, a microphone, or the like. In some embodiments, the input device 315 may be integrated with the output device 320, for example, as a touchscreen or similar touch-sensitive display. In some embodiments, the input device 315 includes a touchscreen such that text may be input using a virtual keyboard displayed on the touchscreen and/or by handwriting on the touchscreen. In some embodiments, the input device 315 includes two or more different devices, such as a keyboard and a touch panel.

The output device 320, in one embodiment, is designed to output visual, audible, and/or haptic signals. In some embodiments, the output device 320 includes an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the user equipment apparatus 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

In certain embodiments, the output device 320 includes one or more speakers for producing sound. For example, the output device 320 may produce an audible alert or notification (e.g., a beep or chime). In some embodiments, the output device 320 includes one or more haptic devices for producing vibrations, motion, or other haptic feedback. In some embodiments, all, or portions of the output device 320 may be integrated with the input device 315. For example, the input device 315 and output device 320 may form a touchscreen or similar touch-sensitive display. In other embodiments, the output device 320 may be located near the input device 315.

The transceiver 325 includes at least transmitter 330 and at least one receiver 335. The transceiver 325 may be used to provide UL communication signals to a base unit 121 and to receive DL communication signals from the base unit 121, as described herein. Similarly, the transceiver 325 may be used to transmit and receive SL signals (e.g., V2X communication), as described herein. Although only one transmitter 330 and one receiver 335 are illustrated, the user equipment apparatus 300 may have any suitable number of transmitters 330 and receivers 335. Further, the transmitter(s) 330 and the receiver(s) 335 may be any suitable type of transmitters and receivers. In one embodiment, the transceiver 325 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 325, transmitters 330, and receivers 335 may be implemented as physically separate components that access a shared hardware resource and/or software resource, such as for example, the network interface 340.

In various embodiments, one or more transmitters 330 and/or one or more receivers 335 may be implemented and/or integrated into a single hardware component, such as a multi-transceiver chip, a system-on-a-chip, an ASIC, or other type of hardware component. In certain embodiments, one or more transmitters 330 and/or one or more receivers 335 may be implemented and/or integrated into a multi-chip module. In some embodiments, other components such as the network interface 340 or other hardware components/circuits may be integrated with any number of transmitters 330 and/or receivers 335 into a single chip. In such embodiment, the transmitters 330 and receivers 335 may be logically configured as a transceiver 325 that uses one more common control signals or as modular transmitters 330 and receivers 335 implemented in the same hardware chip or in a multi-chip module.

In one embodiment, the processor 305 generates an empty MAC PDU according to an UL CG, the empty MAC PDU free of any MAC SDUs. In one embodiment, the transceiver 325 instructs the physical layer to transmit, to a network, the empty MAC PDU on a HARQ process associated with the UL CG. In one embodiment, the processor 305 prevents autonomous retransmission of the empty MAC PDU to the network.

In one embodiment, the processor 305 flushes a HARQ buffer in response to transmitting the empty MAC PDU on the UL CG to prevent autonomous retransmission of the empty MAC PDU.

In one embodiment, the processor 305 flushes the HARQ buffer upon expiration of a CG retransmission timer to prevent autonomous retransmission of the empty MAC PDU.

In one embodiment, the processor 305 does not deliver the UL CG information and associated HARQ information to a HARQ entity.

In one embodiment, the transceiver 325 receives a configuration from the network to flush the HARQ buffer in response to transmitting the empty MAC PDU.

In one embodiment, the processor 305 ignores a UL DG scheduling a retransmission of the empty MAC PDU.

In one embodiment, the processor 305 does not start a CG timer or a CG retransmission timer in response to transmission of the empty MAC PDU to prevent autonomous retransmission of the empty MAC PDU.

In one embodiment, the processor 305 ignores an LBT failure associated with the empty MAC PDU to prevent autonomous retransmission of the empty MAC PDU.

In one embodiment, the processor 305 considers the HARQ process as not pending in case the transmission of the empty MAC PDU on the HARQ process associated with the UL CG is not performed due to an LBT failure.

In one embodiment, the processor 305 multiplexes uplink control information (“UCI”) on the uplink resources allocated by the UL CG that are used for the transmission of the empty MAC PDU.

In one embodiment, the empty MAC PDU comprises one or more of padding information and BSR information.

FIG. 4 depicts one embodiment of a network apparatus 400 that may be used for managing MAC PDU transmissions, according to embodiments of the disclosure. In some embodiments, the network apparatus 400 may be one embodiment of a RAN node and its supporting hardware, such as the base unit 121 and/or gNB, described above. Furthermore, network apparatus 400 may include a processor 405, a memory 410, an input device 415, an output device 420, and a transceiver 425. In certain embodiments, the network apparatus 400 does not include any input device 415 and/or output device 420.

As depicted, the transceiver 425 includes at least one transmitter 430 and at least one receiver 435. Here, the transceiver 425 communicates with one or more remote units 105. Additionally, the transceiver 425 may support at least one network interface 440 and/or application interface 445. The application interface(s) 445 may support one or more APIs. The network interface(s) 440 may support 3GPP reference points, such as Uu, N1, N2, N3, N5, N6 and/or N7 interfaces. Other network interfaces 440 may be supported, as understood by one of ordinary skill in the art.

When implementing an NEF, the network interface(s) 440 may include an interface for communicating with an application function (i.e., N5) and with at least one network function (e.g., UDR, SFC function, UPF) in a mobile communication network, such as the mobile core network 130.

The processor 405, in one embodiment, may include any known controller capable of executing computer-readable instructions and/or capable of performing logical operations. For example, the processor 405 may be a microcontroller, a microprocessor, a CPU, a GPU, an auxiliary processing unit, an FPGA, a DSP, a co-processor, an application-specific processor, or similar programmable controller. In some embodiments, the processor 405 executes instructions stored in the memory 410 to perform the methods and routines described herein. The processor 405 is communicatively coupled to the memory 410, the input device 415, the output device 420, and the transceiver 425. In certain embodiments, the processor 405 may include an application processor (also known as “main processor”) which manages application-domain and OS functions and a baseband processor (also known as “baseband radio processor”) which manages radio function. In various embodiments, the processor 405 controls the network apparatus 400 to implement the above described network entity behaviors (e.g., of the gNB) for managing MAC PDU transmissions.

The memory 410, in one embodiment, is a computer readable storage medium. In some embodiments, the memory 410 includes volatile computer storage media. For example, the memory 410 may include a RAM, including DRAM, SDRAM, and/or SRAM. In some embodiments, the memory 410 includes non-volatile computer storage media. For example, the memory 410 may include a hard disk drive, a flash memory, or any other suitable non-volatile computer storage device. In some embodiments, the memory 410 includes both volatile and non-volatile computer storage media.

In some embodiments, the memory 410 stores data relating to CSI enhancements for higher frequencies. For example, the memory 410 may store parameters, configurations, resource assignments, policies, and the like as described above. In certain embodiments, the memory 410 also stores program code and related data, such as an operating system (“OS”) or other controller algorithms operating on the network apparatus 400, and one or more software applications.

The input device 415, in one embodiment, may include any known computer input device including a touch panel, a button, a keyboard, a stylus, a microphone, or the like. In some embodiments, the input device 415 may be integrated with the output device 420, for example, as a touchscreen or similar touch-sensitive display. In some embodiments, the input device 415 includes a touchscreen such that text may be input using a virtual keyboard displayed on the touchscreen and/or by handwriting on the touchscreen. In some embodiments, the input device 415 includes two or more different devices, such as a keyboard and a touch panel.

The output device 420, in one embodiment, may include any known electronically controllable display or display device. The output device 420 may be designed to output visual, audible, and/or haptic signals. In some embodiments, the output device 420 includes an electronic display capable of outputting visual data to a user. Further, the output device 420 may be a component of a smart phone, a personal digital assistant, a television, a table computer, a notebook (laptop) computer, a personal computer, a vehicle dashboard, or the like.

In certain embodiments, the output device 420 includes one or more speakers for producing sound. For example, the output device 420 may produce an audible alert or notification (e.g., a beep or chime). In some embodiments, the output device 420 includes one or more haptic devices for producing vibrations, motion, or other haptic feedback. In some embodiments, all, or portions of the output device 420 may be integrated with the input device 415. For example, the input device 415 and output device 420 may form a touchscreen or similar touch-sensitive display. In other embodiments, all, or portions of the output device 420 may be located near the input device 415.

As discussed above, the transceiver 425 may communicate with one or more remote units and/or with one or more interworking functions that provide access to one or more PLMNs. The transceiver 425 may also communicate with one or more network functions (e.g., in the mobile core network 80). The transceiver 425 operates under the control of the processor 405 to transmit messages, data, and other signals and also to receive messages, data, and other signals. For example, the processor 405 may selectively activate the transceiver (or portions thereof) at particular times in order to send and receive messages.

The transceiver 425 may include one or more transmitters 430 and one or more receivers 435. In certain embodiments, the one or more transmitters 430 and/or the one or more receivers 435 may share transceiver hardware and/or circuitry. For example, the one or more transmitters 430 and/or the one or more receivers 435 may share antenna(s), antenna tuner(s), amplifier(s), filter(s), oscillator(s), mixer(s), modulator/demodulator(s), power supply, and the like. In one embodiment, the transceiver 425 implements multiple logical transceivers using different communication protocols or protocol stacks, while using common physical hardware.

In one embodiment, the transceiver (425) transmits, to a UE, an indication to prevent autonomous retransmissions of empty MAC PDUs for an UL CG, the empty MAC PDUs free of any MAC SDUs and receives, from the UE, the empty MAC PDU on a HARQ process associated with the UL CG.

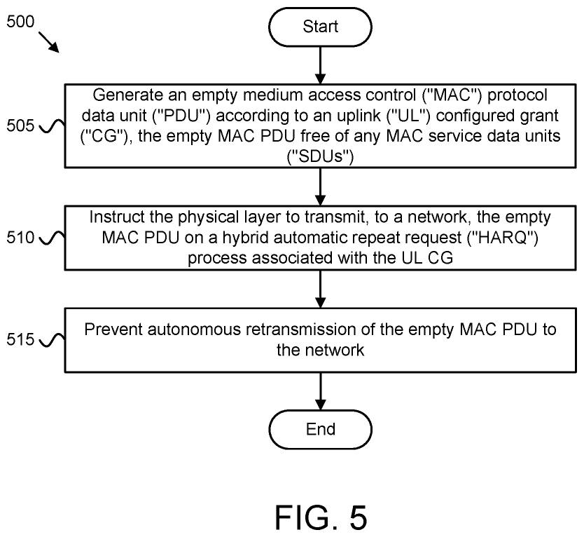

FIG. 5 is a flowchart diagram of a method 500 for managing MAC PDU transmissions. The method 500 may be performed by a UE as described herein, for example, the remote unit 105 and/or the user equipment apparatus 300. In some embodiments, the method 500 may be performed by a processor executing program code, for example, a microcontroller, a microprocessor, a CPU, a GPU, an auxiliary processing unit, a FPGA, or the like.

In one embodiment, the method 500 begins and generates 505 an empty MAC PDU according to an UL CG, the empty MAC PDU free of any MAC SDUs. In one embodiment, the method 500 instructs 510 the physical layer to transmit, to a network, the empty MAC PDU on a HARQ process associated with the UL CG. In one embodiment, the method 500 prevents 515 autonomous retransmission of the empty MAC PDU to the network, and the method 500 ends.

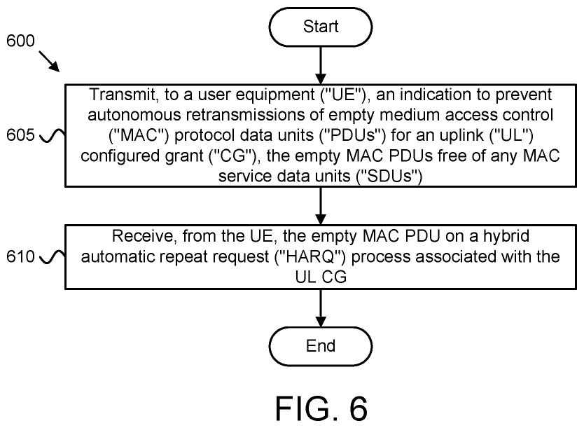

FIG. 6 is a flowchart diagram of a method 600 for managing MAC PDU transmissions. The method 600 may be performed by a network device as described herein, for example, the base station 121, the gNB, and/or the network equipment apparatus 400. In some embodiments, the method 600 may be performed by a processor executing program code, for example, a microcontroller, a microprocessor, a CPU, a GPU, an auxiliary processing unit, a FPGA, or the like.

In one embodiment, the method 600 begins and transmits 605, to a UE, an indication to prevent autonomous retransmissions of empty MAC PDUs for a UL CG, the empty MAC PDUs free of any MAC SDUs. In one embodiment, the method 600 receives 610, from the UE, the empty MAC PDU on a HARQ process associated with the UL CG, and the method 600 ends.

Disclosed herein is a first apparatus for managing MAC PDU transmissions. The first apparatus may include a UE as described herein, for example, the remote unit 105 and/or the user equipment apparatus 300. In some embodiments, the first apparatus may include a processor executing program code, for example, a microcontroller, a microprocessor, a CPU, a GPU, an auxiliary processing unit, a FPGA, or the like.

In one embodiment, the first apparatus includes a processor that generates an empty MAC PDU according to an UL CG, the empty MAC PDU free of any MAC SDUs. In one embodiment, the first apparatus includes a transceiver that instructs the physical layer to transmit, to a network, the empty MAC PDU on a HARQ process associated with the UL CG. In one embodiment, the processor prevents autonomous retransmission of the empty MAC PDU to the network.

In one embodiment, the processor flushes a HARQ buffer in response to transmitting the empty MAC PDU on the UL CG to prevent autonomous retransmission of the empty MAC PDU.

In one embodiment, the processor flushes the HARQ buffer upon expiration of a CG retransmission timer to prevent autonomous retransmission of the empty MAC PDU.

In one embodiment, the processor does not deliver the UL CG information and associated HARQ information to a HARQ entity.

In one embodiment, the transceiver receives a configuration from the network to flush the HARQ buffer in response to transmitting the empty MAC PDU.

In one embodiment, the processor ignores a UL DG scheduling a retransmission of the empty MAC PDU.

In one embodiment, the processor does not start a CG timer or a CG retransmission timer in response to transmission of the empty MAC PDU to prevent autonomous retransmission of the empty MAC PDU.

In one embodiment, the processor ignores an LBT failure associated with the empty MAC PDU to prevent autonomous retransmission of the empty MAC PDU.

In one embodiment, the processor considers the HARQ process as not pending in case the transmission of the empty MAC PDU on the HARQ process associated with the UL CG is not performed due to an LBT failure.

In one embodiment, the processor multiplexes uplink control information (“UCI”) on the uplink resources allocated by the UL CG that are used for the transmission of the empty MAC PDU.

In one embodiment, the empty MAC PDU comprises one or more of padding information and BSR information.

Disclosed herein is a first method for managing MAC PDU transmissions. The first method may be performed by a UE as described herein, for example, the remote unit 105 and/or the user equipment apparatus 300. In some embodiments, the first method may be performed by a processor executing program code, for example, a microcontroller, a microprocessor, a CPU, a GPU, an auxiliary processing unit, a FPGA, or the like.

In one embodiment, the first method generates an empty MAC PDU according to an UL CG, the empty MAC PDU free of any MAC SDUs. In one embodiment, the first method instructs the physical layer to transmit, to a network, the empty MAC PDU on a HARQ process associated with the UL CG. In one embodiment, the first method prevents autonomous retransmission of the empty MAC PDU to the network.

In one embodiment, the first method flushes a HARQ buffer in response to transmitting the empty MAC PDU on the UL CG to prevent autonomous retransmission of the empty MAC PDU.

In one embodiment, the first method flushes the HARQ buffer upon expiration of a CG retransmission timer to prevent autonomous retransmission of the empty MAC PDU.

In one embodiment, the first method does not deliver the UL CG information and associated HARQ information to a HARQ entity.

In one embodiment, the first method receives a configuration from the network to flush the HARQ buffer in response to transmitting the empty MAC PDU.

In one embodiment, the first method ignores a UL DG scheduling a retransmission of the empty MAC PDU.

In one embodiment, the first method does not start a CG timer or a CG retransmission timer in response to transmission of the empty MAC PDU to prevent autonomous retransmission of the empty MAC PDU.

In one embodiment, the first method ignores an LBT failure associated with the empty MAC PDU to prevent autonomous retransmission of the empty MAC PDU.

In one embodiment, the first method considers the HARQ process as not pending in case the transmission of the empty MAC PDU on the HARQ process associated with the UL CG is not performed due to an LBT failure.

In one embodiment, the first method multiplexes uplink control information (“UCI”) on the uplink resources allocated by the UL CG that are used for the transmission of the empty MAC PDU.

In one embodiment, the empty MAC PDU comprises one or more of padding information and BSR information.

Disclosed herein is a second apparatus for managing MAC PDU transmissions. The second apparatus may include a network device as described herein, for example, the base station 121, the gNB, and/or the network equipment apparatus 400. In some embodiments, the second apparatus includes a processor executing program code, for example, a microcontroller, a microprocessor, a CPU, a GPU, an auxiliary processing unit, a FPGA, or the like.

In one embodiment, the second apparatus includes a transceiver that transmits, to a UE, an indication to prevent autonomous retransmissions of empty MAC PDUs for an UL CG, the empty MAC PDUs free of any MAC SDUs and receives, from the UE, the empty MAC PDU on a HARQ process associated with the UL CG.

Disclosed herein is a second method for managing MAC PDU transmissions. The second method may be performed by a network device as described herein, for example, the base station 121, the gNB, and/or the network equipment apparatus 400. In some embodiments, the second method may be performed by a processor executing program code, for example, a microcontroller, a microprocessor, a CPU, a GPU, an auxiliary processing unit, a FPGA, or the like.

In one embodiment, the second method transmits, to a UE, an indication to prevent autonomous retransmissions of empty MAC PDUs for an UL CG, the empty MAC PDUs free of any MAC SDUs and receives, from the UE, the empty MAC PDU on a HARQ process associated with the UL CG.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus, comprising:
a processor that generates an empty medium access control (“MAC”) protocol data unit (“PDU”) according to an uplink (“UL”) configured grant (“CG”), the empty MAC PDU free of any MAC service data units (“SDUs”); and
a transceiver that instructs the physical layer to transmit, to a network, the empty MAC PDU on a hybrid automatic repeat request (“HARQ”) process associated with the UL CG,
wherein the processor prevents autonomous retransmission of the empty MAC PDU to the network.

2. The apparatus of claim 1, wherein the processor flushes a HARQ buffer in response to transmitting the empty MAC PDU on the UL CG to prevent autonomous retransmission of the empty MAC PDU.

3. The apparatus of claim 2, wherein the processor flushes the HARQ buffer upon expiration of a CG retransmission timer to prevent autonomous retransmission of the empty MAC PDU.

4. The apparatus of claim 2, wherein the processor does not deliver the UL CG information and associated HARQ information to a HARQ entity.

5. The apparatus of claim 2, wherein the transceiver receives a configuration from the network to flush the HARQ buffer in response to transmitting the empty MAC PDU.

6. The apparatus of claim 1, wherein the processor ignores a UL DG scheduling a retransmission of the empty MAC PDU.

7. The apparatus of claim 1, wherein the processor does not start a CG timer or a CG retransmission timer in response to transmission of the empty MAC PDU to prevent autonomous retransmission of the empty MAC PDU.

8. The apparatus of claim 1, wherein the processor ignores a listen before talk (“LBT”) failure associated with the empty MAC PDU to prevent autonomous retransmission of the empty MAC PDU.

9. The apparatus of claim 1, wherein the processor considers the HARQ process as not pending in case the transmission of the empty MAC PDU on the HARQ process associated with the UL CG is not performed due to an LBT failure.

10. The apparatus of claim 1, wherein the processor multiplexes uplink control information (“UCI”) on the uplink resources allocated by the UL CG that are used for the transmission of the empty MAC PDU.

11. The apparatus of claim 1, wherein the empty MAC PDU comprises one or more of padding information and buffer status reporting (“BSR”) information.

12. A method, comprising:
generating an empty medium access control (“MAC”) protocol data unit (“PDU”) according to an uplink (“UL”) configured grant (“CG”), the empty MAC PDU free of any MAC service data units (“SDUs”);
instructing the physical layer to transmit, to a network, the empty MAC PDU on a hybrid automatic repeat request (“HARQ”) process associated with the UL CG; and
preventing autonomous retransmission of the empty MAC PDU to the network.

13. The method of claim 12, further comprising flushing a HARQ buffer in response to transmitting the empty MAC PDU on the UL CG to prevent autonomous retransmission of the empty MAC PDU.

14. The method of claim 13, further comprising flushing the HARQ buffer upon expiration of a CG retransmission timer to prevent autonomous retransmission of the empty MAC PDU.

15. An apparatus, comprising:
a transceiver that:
transmits, to a user equipment (“UE”), an indication to prevent autonomous retransmissions of empty medium access control (“MAC”) protocol data units (“PDUs”) for an uplink (“UL”) configured grant (“CG”), the empty MAC PDUs free of any MAC service data units (“SDUs”); and
receives, from the UE, the empty MAC PDU on a hybrid automatic repeat request (“HARQ”) process associated with the UL CG.
